(19) United States
(12) Patent Application Publication
(10) Pub. No.: US 2026/0167087 A1
(43) Pub. Date: Jun. 18, 2026

(54) BRAKE FOR A TIE-DOWN

(71) Applicant: Ping-Chun Huang, Taichung City (TW)

(72) Inventor: Ping-Chun Huang, Taichung City (TW)

(21) Appl. No.: 18/979,505

(22) Filed: Dec. 12, 2024

(51) Int. Cl. B60P 7/08

(52) U.S. Cl. CPC B60P 7/0853; B60P 7/0846

(57) ABSTRACT

A tie-down includes a long strap, a shaft for winding the long strap, a frame for supporting the shaft, a gear connected to the shaft, and a brake. The brake includes a housing attached to the frame and a detent movable in the housing between two positions. In the first position, the detent engages with the gear to prevent the shaft from rotation. In the second position, the detent disengages from the gear to allow the shaft to rotate.

### BACKGROUND OF INVENTION

### 1. Field of Invention

The present invention relates to a tie-down and, more particularly, to a brake for a tie-down to facilitate replacement of a used long strap of the tie-down with a new one.

### 2. Related Prior Art

A conventional tie-down is equipped with a scroll spring for rotating a reel shaft to retract a long strap. The tie-down is tied to a short strap that cooperates with the long strap to bind objects. Some of the objects might include right or sharp angles that could wear and eventually cut the straps, thereby jeopardizing the binding of the objects.

For security of the objects, it seems to be a good option to replace the entire tie-down with a new one. However, it costs quite some money to replace the tie-down with a new one as a tie-down is expensive for including a lot of metal components.

It is an inexpensive option to replace a damaged strap with a new one. During the replacement, a damaged long strap must be pulled out of the tie-down in its entirety, thereby causing the reel shaft to shrink and load the scroll spring. A specific machine is required to keep the scroll spring shrunk and loaded. After replacing the strap with a new one, the scroll spring is released from the machine and hence allowed to rotate the reeling shaft to retract the new strap.

An average user does not have knowledge or experience for conducting such replacement alone since the scroll spring tends to expand and release the load, i.e., retracting the long strap. The long strap could seriously cut the user.

To address the above-mentioned issue, a tool for replacing a strap of a tie-down has been disclosed in U.S. Pat. No. 11,338,720 issued to the present inventor.

The present inventor intends to provide a tie-down from which a long strap can be released while preventing a scroll spring from retracting the long strap.

### SUMMARY OF INVENTION

It is the primary objective of the present invention to provide an easy and safe-to-use tie-down.

To achieve the foregoing objective, the tie-down includes a long strap, a shaft for winding the long strap, a frame for supporting the shaft, a gear connected to the shaft, and a brake. The brake includes a housing attached to the frame and a detent movable in the housing between two positions. In the first position, the detent engages with the gear to prevent the shaft from rotation. In the second position, the detent disengages from the gear to allow the shaft to rotate.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a brake according to the preferred embodiment of the present invention;

FIG. 2 is a side view of the brake shown in FIG. 1;

FIG. 3 is another side view of the brake shown in FIG. 1;

FIG. 4 is a perspective view of a tie-down and the brake depicted in FIG. 1;

FIG. 5 is a cross-sectional view of the tie-down and brake depicted in FIG. 1; and

FIG. 6 is a perspective view of another tie-down and the brake shown in FIG. 1.

### DETAILED DESCRIPTION OF PREFERRED EMBODIMENT

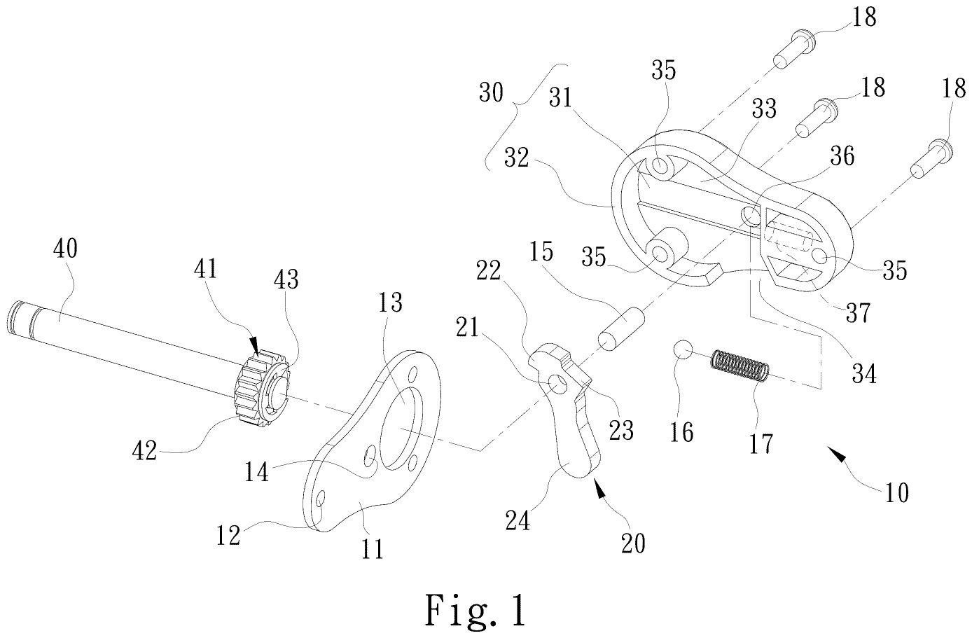

Referring to FIG. 1, a brake 10 includes a plate 11, an axle 15, a bead 16, a compression spring 17, three fasteners 18, a detent 20 and a shell 30 according to the preferred embodiment of the present invention.

The plate 11 includes three aperatures 12, an opening 13 and an orifice 14. The apertures 12 are like three vertices of a triangle and are arranged around the opening 13 and the orifice 14. The orifice 14 is in a middle part of the plate 11. The opening 13 is adjacent to the orifice 14. A diameter of the opening 13 is larger than a diameter of the orifice 14.

The shell 30 includes a panel 31 shaped corresponding to the plate 11 and a rim 32 extending around the panel 31, The panel 31 and the rim 32 together provide a space 33. An orifice 36 is made in a middle portion of the panel 31, and the orifice 36 is in communication with the space 33. The rim 32 is in contact with the plate 11. The axle 15 extends through the orifices 14 and 36, which are aligned to each other.

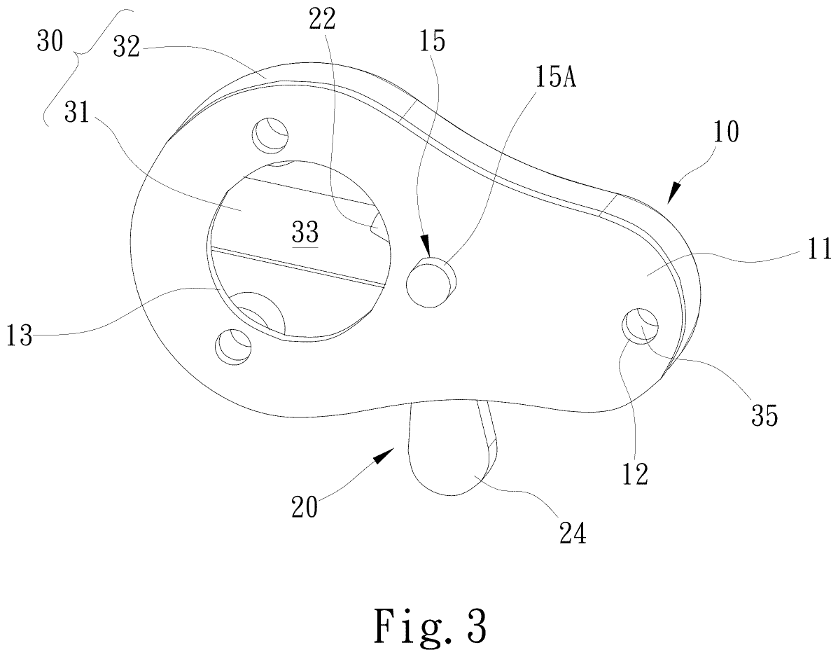

Referring to FIG. 3, the axle 15 includes a middle section extending in the space 33. The axle 15 is punched at two ends 15A, thereby turning the ends 15A into enlarged ends. A common diameter of the enlarged ends 15A is larger than a common diameter of the orifices 14 and 36. Thus, the axle 15 keeps the plate 11 in contact with the shell 30, thereby providing a housing (not numbered). The space 33 is in communication with exterior of the housing through the opening 13.

Referring to FIG. 1, the detent 20 is an elongated element including an orifice 21 that divide the detent 20 into a shorter section and a longer section. The shorter section of the detent 20 is formed with a hook 22 and a pointed portion 23. The hook 22 extends substantially opposite to the pointed portion 23. The longer section of the detent 20 is formed with a switch 24.

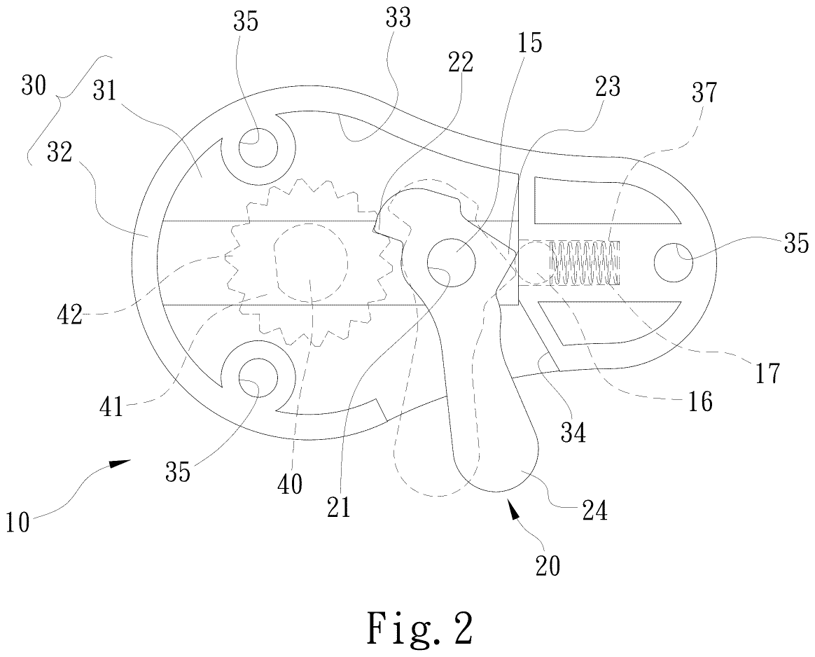

Referring to FIG. 2, the orifice 21 receives the middle section of the axle 15, which extends in the space 33. The hook portion 22 and the pointed portion 23 extend in the space 33 while the switch 24 extends out of the space 33 via a notch 34 made in the rim 32. The pointed portion 23 extends toward a pocket 37 made in the shell 30. The switch 24 is maneuverable to pivot the detent 20 about the axle 15 between a first position shown by a solid line and a second position shown by broken lines.

It is not difficult to understand from FIG. 1 that a bump (not numbered) includes a side in contact with the panel 31 and an end in contact with the rim 32. The pocket 37 is made in the bump. The pocket 37 includes an open end and a closed end. The pocket 37 receives the entire compression spring 17 and a first portion of the bead 16.

Referring to FIG. 2, an end of the compression spring 17 is in contact with the closed part of the pocket 37, and another end of the compression spring 17 is in contact with the bead 16. The compression spring 17 is compressed between the closed end of the pocket 37 and the bead 16. Thus, a second portion of the bead 16 extends from the pocket 37 via the open end. The second portion of the bead 16 is in contact with a selected one of two facets of the pointed portion 23 of the detent 20, thereby keeping the detent 20 in the first or second position.

In addition, the shell 30 includes three apertures 35 corresponding to the apertures 12. One of the apertures 35 is made in the bump, in which the pocket 37 is made. Preferably, this aperture 35 is separated from the pocket 37. The apertures 35 are respectively aligned to the apertures 12 as the plate 11 is connected to the shell 30 (FIG. 3).

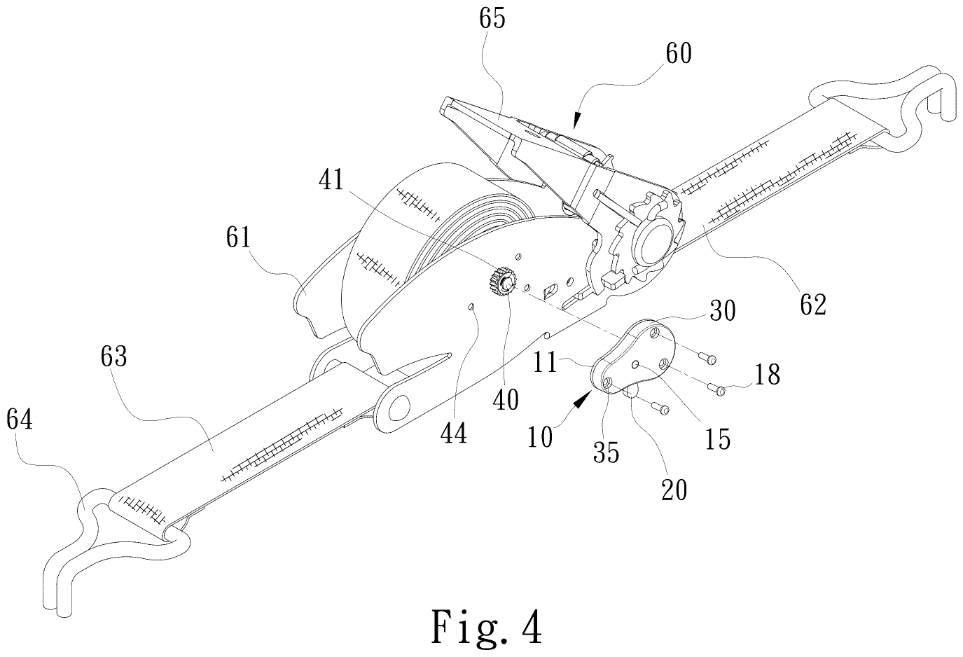

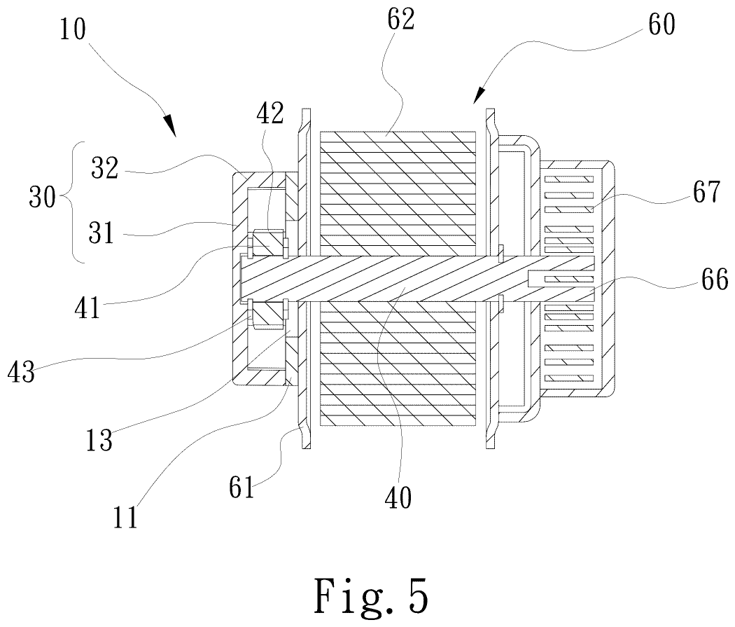

Referring to FIGS. 1, 2, 4 and 5, a tie-down 60 includes a frame 61, a shaft 40, a reel (not numbered), a long strap 62, a short strap 63, two hooks 64, a handle 65 and a scroll spring 67. The shaft 40 is supported on the frame 61. The reel is connected to the shaft 40. The long strap 62 is wound on the reel. The short strap 63 is connected to the frame 61. The hooks 64 are connected to the straps 62 and 63. The handle 65 is operable to rotate the shaft 40 relative to the frame 61 in a direction, thereby winding the long strap 62 onto the reel, i.e., retracting the long strap 62. The scroll spring 67 includes an external end connected to the frame 61 and an internal end connected to a bifurcated end 66 of the shaft 40. The scroll spring 67 is operable to retract the long strap 62. The scroll spring 67 and the gear 41 are at two ends of the shaft 40. The scroll spring 67 is further loaded as the long strap 62 is released from the reel, which is connected to the shaft 40. Preferably, a protective cover (unnumbered) is attached to the frame 61 to protectively cover the scroll spring 67.

A gear 41 includes a D-shaped bore (not numbered) for receiving a D-shaped cross-section of the shaft 40 so that they are not rotatable relative to each other, i.e., they are rotatable with each other. The gear 41 is formed with teeth 42. Two C-clips 43 are engaged with the shaft 40. The gear 41 is kept between the C-clips 43.

In used, the shaft 40 is inserted in the space 33 through the opening 13. When the detent 20 is in the first position, the hook 22 is engaged with at least one of the teeth 42 so that the detent 20 prevents the shaft 40 from rotating through the gear 41. Hence, the shaft 40 is braked. which is equivalent to a braking effect. When the detent 20 is in the second position, the hook 22 is disengaged from the teeth 42, thereby allowing the shaft 40 to rotate freely.

The fasteners 18 are inserted in three holes 44 made in the frame 61 to attach the brake 10 to the frame 61 so that the housing of the brake 10 covers the gear 41. Now, the brake 10 is ready to keep the shaft 40 from rotation while the long strap 62 is replaced with a new one.

In the first position, the hook 22 is engaged with at least one of the teeth 42 to prevent the gear 41 and hence the shaft 40 from rotation. Thus, the long strap 62 cannot be retracted fast. Hence, the long strap 62 cannot hurt a user. The replacement of the long strap 62 with a new one can be conducted without any risk of hurting a user.

In the second position, the hook 22 is disengaged from the teeth 42 to allow the gear 41 to and hence the shaft to rotate. Thus, the scroll spring 67 is allowed to rotate the shaft 40 to retract the long strap 62, and the tie-down 60 is ready for normal use.

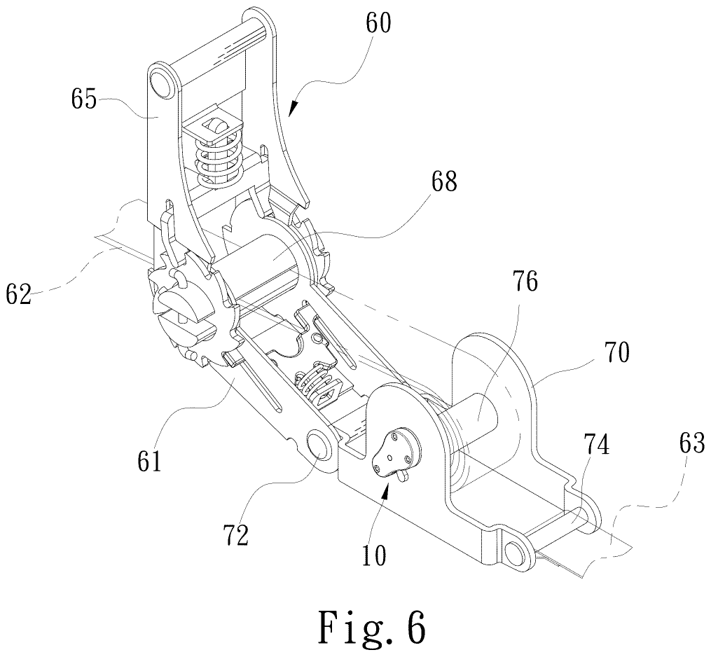

Referring to FIG. 6, there is a tie-down according to a second embodiment of the present invention. The second embodiment is like the first embodiment except for three things. Firstly, a reel/shaft 68 is used instead of the combination of the reel with the shaft 40. The reel/shaft 68 includes a transverse slit for receiving the long strap 62. Secondly, a secondary frame 70 is connected to the frame 61 by a coupling rod 72. Thirdly, the short strap 63 is connected to the secondary frame 70 by a coupling rod 74. A reel/shaft 76 is supported on the auxiliary frame 70 and used to wind a section of the long strap 62.

In the second embodiment, instead of the shaft 40, the reel/shaft 76 is used to retract the long strap 62. Hence, the gear 41 is connected to the reel/shaft 76, and the housing of the brake 10 is attached to the secondary frame 70. The brake 10 is activated to stop the reel/shaft 76. After the long strap 62 is replaced with a new one, the brake 10 is disactivated to allow the reeling shaft 76 to rotate. Thus, the winding function is restored.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A tie-down including:
a long strap;
a shaft for winding the long strap;
a frame for supporting the shaft;
a gear connected to the shaft;
a brake including a housing attached to the frame and a detent movable in the housing between a first position and a second position, wherein the detent engages with the gear in the first position to prevent the shaft from rotation, wherein the detent disengages from the gear in the second position to allow the shaft to rotate.

2. The tie-down according to claim 1, wherein the housing includes:
a plate including an opening;
a shell including a panel corresponding to the plate and a rim extending around the panel, wherein the rim is connected to the plate, wherein the gear is inserted in the housing via the opening.

3. The tie-down according to claim 1, further including an axle for supporting the detent, wherein the axle is inserted in and connected to the housing.

4. The tie-down according to claim 1, wherein the detent includes a hook for engagement with the gear.

5. The tie-down according to claim 1, wherein the detent includes a switch operable to move the detent between the first and second positions, wherein the switch extends out of the housing.

6. The tie-down according to claim 5, wherein the housing includes a notch through which the switch extends from the housing.

7. The tie-down according to claim 1, further comprising a bead, wherein the detent includes a pointed portion formed with a first facet and a second facet, wherein the bead is in contact with the first facet of the pointed portion of the detent to keep the detent in the first position, wherein the bead is in contact with the second facet of the pointed portion of the detent to keep the detent in the second position.

8. The tie-down according to claim 7, further includes a compression spring for biasing the bead toward the pointed portion of the detent.

9. The tie-down according to claim 8, wherein the housing includes a pocket for receiving the compression spring and a portion of the bead.
